(19) United States
(12) Patent Application Publication
(10) Pub. No.: US 2009/0251016 A1
(43) Pub. Date: Oct. 8, 2009

(54) Rotor for an Electrical Machine and Electrical Machine Comprising such a Rotor

(75) Inventor: Michael Zisler, Euerdorf-Wirmsthal (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/374,160

(22) PCT Filed: Jul. 4, 2007
(86) PCT No.: PCT/EP07/56704

§ 371 Date: Jan. 16, 2009

(30) Foreign Application Priority Data
Jul. 17, 2006 (DE) 10 2006 032 992.9

(51) Int. Cl. H02K 7/102; F16D 65/00

(52) U.S. Cl. 310/77; 188/73.2

(57) ABSTRACT

The invention relates to a rotor (23) for an electrical machine (1), comprising a rotor shaft (4), rotor laminations (5), and a rotor brake body (6). The rotor laminations (5) and the rotor brake body (6) are fixed to the rotor shaft in an axially interspaced manner. According to the invention, the rotor laminations (5) and the rotor brake body (6) are directly interconnected in a rotationally fixed manner.

The invention relates to a rotor for an electrical machine, the rotor having a rotor shaft, a rotor lamination bundle and a rotor brake body. The rotor lamination bundle and the rotor brake body are fastened, spaced apart axially, on the rotor shaft.

The invention relates, furthermore, to an electrical machine comprising a stator and such a rotor.

Rotating electrical machines, in particular electric motors, have a stator and a rotatably mounted rotor. The rotor typically has a rotor lamination bundle which is fastened on a rotor shaft.

Electrical machines are known which are used in robotics or for the positioning of drive components connected to the rotor shaft.

Such electrical machines preferably have a brake device for braking the rotor and the drive components connected to it.

The brake device may be a retaining brake for retaining the rotor and the drive components connected to it, when the electrical machine is in the currentless state. Such electrical machines are also designated as servomotors.

The brake device may also be an emergency brake. When an emergency brake is triggered, the electrical machine and also the drive components connected to the electrical machine can be braked reliably. An emergency may be, for example, the failure of the electrical machine, the failure of a feeding converter or the failure of a control of the electrical machine. The braking of the rotor and of the drive components connected to it prevent, for example, an unbraked travel of a drive component up against a mechanical stop.

In such electrical machines, the rotor lamination bundle and a rotor brake body, as an integral part of the brake device, are fastened, spaced apart axially, on the rotor shaft. The term “axially” refers to a direction parallel to the axis of rotation of the electrical machine. The rotor brake body is typically of rotationally symmetrical design. For fastening, the rotor brake body may be shrunk fixedly in terms of rotation onto the rotor shaft.

Alternatively or additionally, the rotor brake body may be screwed or pinned to the rotor shaft.

The rotor and the drive components connected to it can be braked via a brake force acting on the radial or axial outside of the rotor brake body. The term “radially” refers to a direction toward or away from the axis of rotation. The rotor brake body is preferably of robust design for the thermal absorption of the braking energy.

The brake device, in order to apply the brake force, may have a brake shoe which can be pressed by means of an actuating device against the radial and/or axial outside of the rotor brake body. The brake shoe and the associated actuating device are preferably mounted in a machine housing of the electrical machine. Actuation may take place electromechanically, pneumatically or hydraulically.

Alternatively, the brake device may have an armature disk which is mounted fixedly in terms of rotation, via axially acting spring elements, on an axial outside of the rotor brake body. A stationary stator brake body lies axially opposite the armature disk. In or on the stator brake body, permanent magnets may be mounted, which pull the armature disk onto the stator brake body in order to apply a brake force. Furthermore, to generate an opposing magnetic field, current coils may be mounted in or on the stator brake body. When the current coils are excited by means of an electrical current, the brake force is canceled.

When the electrical machines described above are used, particularly in robotics or for positioning, a rotary encoder with high rotary angle resolution is required. The rotary encoder is typically mounted at one axial end of the rotor shaft of the electrical machine. The rotary encoder signals emitted by the rotary encoder are required in order to regulate a high-dynamic automatic control unit of a converter.

A disadvantage of the rotor set-up described above is the reaction of the brake device on the control behavior of the electrical machine and of the feeding converter. In particular, the inert mass of the brake body reacts on the rotary encoder in high-dynamic applications. This may lead to an instability of the control circuit. This is caused by torsional oscillations which are generated by the rotor brake body and are incorrectly detected by the rotary encoder or by the following automatic control device as movement.

The tangential offset usually amounts to markedly less than 1°. In the case of a high acceleration or braking of the rotor, however, this offset may lead to torsional pendulum movements between the rotor lamination bundle and the rotor brake body. These are caused by the elastic behavior of the rotor shaft under torsional stress.

The torsional oscillations generated have one or more typical resonant frequencies. To suppress the torsional oscillations for control purposes, filter systems tuned to the respective resonant frequency are required.

One object of the invention is to specify a rotor for an electrical machine, by means of which rotor the disadvantages described above are avoided.

A further object of the invention is to specify a suitable electrical machine.

The object is achieved by means of a rotor for an electrical machine, having the features of patent claim 1. Advantageous embodiments of the rotor are mentioned in the dependent claims 2 to 8. A suitable electrical machine comprising a rotor according to the invention is specified in claim 9. Advantageous embodiments of the electrical machine are mentioned in claims 10 to 13.

According to the invention, the rotor lamination bundle and the rotor brake body of the rotor are directly connected fixedly in terms of rotation to one another. In particular, torque transmission from the rotor lamination bundle to the rotor brake body, and vice versa, is based on a nonpositive rotationally fixed connection. Torque transmission may additionally take place via a positive connection.

Owing to the direct mechanical tie-up, there is no tangential offset or twist between the rotor lamination bundle and rotor brake body, as is the case particularly with rotors according to the prior art. The term “tangentially” refers to a direction about the axis of rotation.

The direct connection between the rotor lamination bundle and rotor brake body increases the rigidity of the overall rotor. As a result, the resonant frequencies of the torsional oscillations are displaced toward higher frequencies. These can be as far as possible smoothed out. At the same time, the torsional oscillations have low amplitude, as compared with the prior art.

An electrical machine comprising such a rotor can advantageously be operated in a more highly dynamic way. Filter systems for suppressing the resonant frequencies may be dispensed with.

In a particular embodiment, the rotor lamination bundle and the rotor brake body are connected to one another via their axial outsides which in each case face one another.

The mechanical connection may be, for example, an adhesive connection. In this case, an adhesive layer is applied to one or to both of the axial outer surfaces which in each case face one another. After the rotor lamination bundle and the rotor brake body have been pressed together axially, and after subsequent curing, high torque transmission from the rotor lamination bundle to the rotor brake body, and vice versa, is possible.

Alternatively or additionally, a weld seam or a row of weld spots may also be applied along the continuous radially outer joint between the rotor lamination bundle and rotor brake body.

According to a further embodiment, the rotor lamination bundle and the rotor brake body are connected to one another via an axially acting fastening device.

The fastening device may be, for example, a tensioning structure or a clamp which braces the rotor lamination bundle and the rotor brake body with one another.

In a preferred embodiment, the fastening device has a plurality of fastening means. The fastening means are arranged, distributed regularly in the circumferential direction. In particular, the fastening means are arranged, offset at an identical angle with respect to one another. The distribution of the fastening means may alternatively also take place within predefined regions.

This advantageously ensures a uniform torque transmission from the rotor lamination bundle to the rotor brake body, and vice versa.

The fastening means may be, for example, screws, bolts, pins or bosses.

Preferably, according to a further embodiment, clearances running axially are present in the rotor lamination bundle and the rotor brake body. Moreover, the fastening device has fastening means which are arranged in the clearances.

The axial arrangement of the clearances and of the fastening means introduced therein simplifies assembly.

The clearances preferably have a circular cross section. In particular, the clearances are bores for the introduction of a bolt, of an expanding dowel, of a boss or of a screw.

In each case an internal thread may be introduced in the axial clearances in the rotor lamination bundle. The axial bores in the rotor brake body have a cross section which is slightly larger than the cross section of an axial clearance having an internal thread.

The axial clearances and the bores are coordinated with one another in such a way that the rotor lamination bundle and the rotor brake body can be screwed together with one another from the axial outside, facing away from the rotor lamination bundle, of the rotor brake body. For this purpose, the screws are inserted in each case through a bore in the rotor brake body. The rotor brake body is subsequently screwed together with the rotor lamination bundle, in that the screws engage into the respective internal thread in the rotor lamination bundle. The rotor lamination bundle and rotor brake body are then braced with one another.

Alternatively or additionally, the screwing together of the rotor lamination bundle and rotor brake body may take place via the axial outside, facing away from the rotor brake body, of the rotor lamination bundle.

The fastening possibility described above is to be considered by way of example. A person skilled in the art is aware of many different alternative fastening possibilities for connecting mechanical structural elements firmly to one another. Thus, in addition to screws, clamping sleeves, dowels, bosses and also conical elements for expanding the bosses may be used.

According to a further embodiment, the rotor lamination bundle and the rotor brake body have a radial extent which varies between a minimum value and a maximum value along the rotor shaft. Moreover, the clearances are at a radial distance from the rotor shaft which is lower than the minimum value.

The minimum extent denotes a radial distance in the region of the rotor lamination bundle and of the rotor brake body, along the axis of rotation, in the case of which a corresponding axially running intersection line would still run completely or at least virtually completely in the rotor lamination bundle and rotor brake body.

With this proviso, the fastening means are at as great a radial distance as possible from the axis of rotation. Moreover, the fastening means are surrounded at least virtually completely by a material or by a combination of a plurality of materials of the rotor lamination bundle or of the rotor brake body. High torque transmission between the two rotor bodies is thereby possible.

According to a further embodiment, the rotor brake body is additionally connected fixedly in terms of rotation to the rotor shaft by means of radially acting fastening elements. Screws, bolts, bosses, etc. may be used as fastening means.

This measure further increases the rigidity of the overall rotor.

In particular, according to a further embodiment, the rotor brake body is shrunk onto the rotor shaft.

Shrinking on gives rise to a rotationally fixed nonpositive connection. With this type of fastening, fastening means may advantageously be dispensed with.

The object of the invention is achieved, furthermore, by means of an electrical machine, in particular by means of an electric motor, which has a stator and a rotor according to the invention.

An electrical machine comprising such a rotor can advantageously be operated in a more highly dynamic manner.

In particular, as a result of one embodiment, the electrical machine has a brake device for braking and/or retaining the rotor. The rotor brake body is an integral part of the brake device and is designed to be essentially rotationally symmetrical with respect to the axis of rotation of the rotor shaft.

The brake device may have an actuating device for actuating a brake shoe or brake lining. By means of the actuating device, the rotor brake body can be braked and/or retained via its radial and/or axial outside. The brake shoe and the associated actuating device are preferably mounted in a machine housing of the electrical machine. Actuation may take place electromechanically, pneumatically or hydraulically.

According to a further embodiment, the electrical machine has a rotary encoder which is fastened to one axial end of the rotor shaft.

Control or regulation of the electrical machine via an associated converter is thereby possible.

According to a particular embodiment, the rotary encoder is fastened to an axial end, adjacent to the rotor brake body, of the rotor shaft.

Owing to the short axial distance between the rotor brake body and rotary encoder, the torsional elasticity of the rotor and, in particular, of the rotor shaft can be ignored for control purposes. The control or regulation of the electrical machine may advantageously take place even more dynamically.

In particular, the electrical machine is a servomotor. Such servomotors are required, in particular, in robotics and for the positioning of machine and plant components.

Further advantageous designs and preferred developments of the invention may be gathered from the subclaims.

The invention and advantageous versions of it are described in more detail below with reference to the following figures in which:

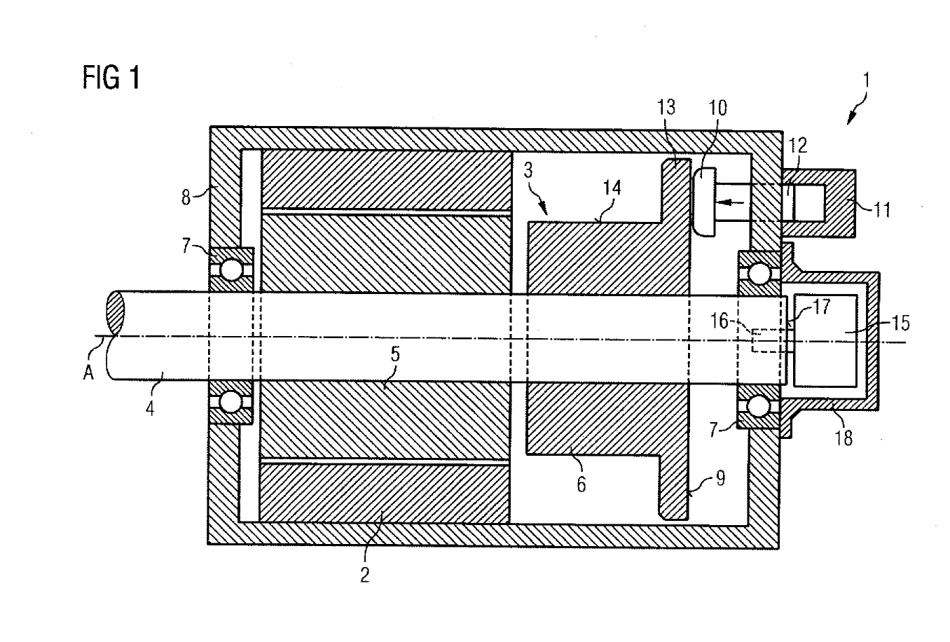

FIG. 1 shows a longitudinal section through an electrical machine according to the prior art in a simplified illustration,

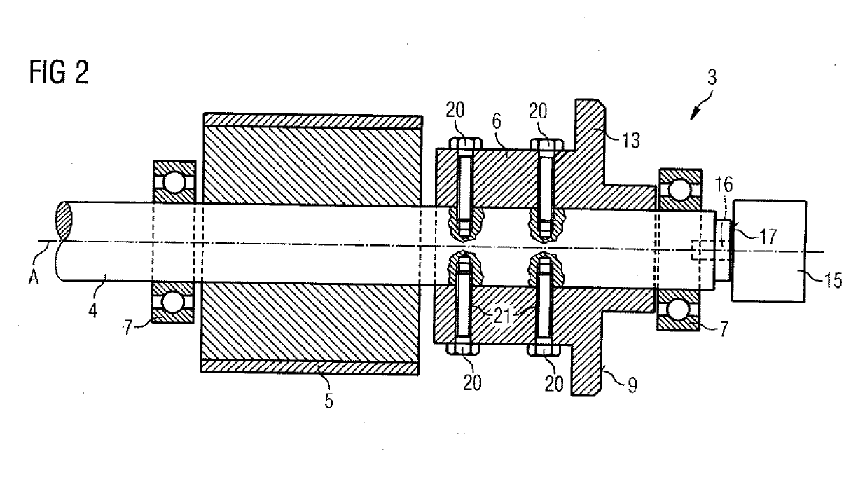

FIG. 2 shows a longitudinal section through a rotor according to the prior art,

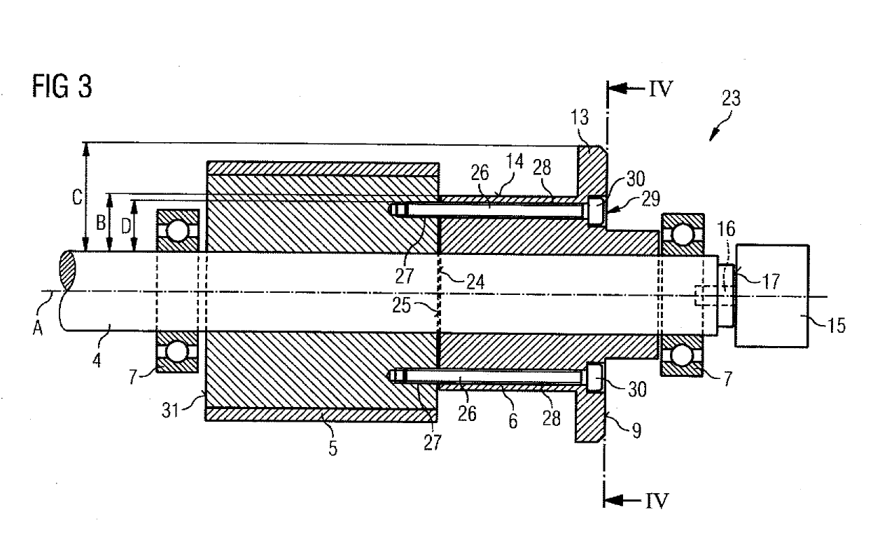

FIG. 3 shows a longitudinal section through a rotor according to the invention, and

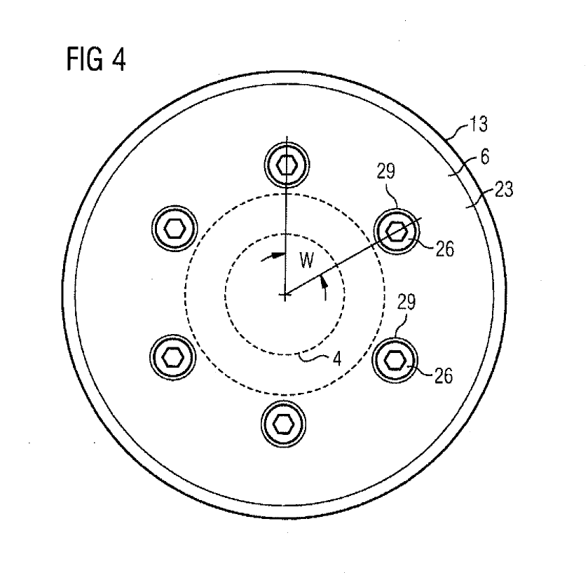

FIG. 4 shows a longitudinal section through the rotor according to the invention along a sectional line IV-IV depicted in FIG. 3.

FIG. 1 shows a longitudinal section through an electrical machine 1 according to the prior art in a simplified illustration.

In the example of the present FIG. 1, the electrical machine 1 is a mechanically brakeable electric motor.

The machine 1 has a stator 2 and a rotor 3. The rotor 3 has a rotor shaft 4, a rotor lamination bundle 5 and a rotor brake body 6. The rotor lamination bundle 5 and the rotor brake body 6 are fastened fixedly in terms of rotation on the rotor shaft 4. The axis of rotation of the electrical machine 1 is designated by reference symbol A. The axis of rotation A coincides with the axis of symmetry of the rotor lamination bundle 5 and of the rotor brake body 6. Conventionally, the rotor lamination bundle 5 and the rotor brake body 6 are mounted, spaced apart axially, on the rotor shaft 4. In the prior art, torque transmission from the rotor lamination bundle 5 to the rotor brake body 6 takes place solely or virtually solely via the rotor shaft 4.

The rotor shaft 4 is guided at its respective axial end in a bearing 7, such as, for example, a rolling bearing. The bearings 7 and the stator 2 are conventionally arranged in a machine housing 8 of the electrical machine 1.

The rotor brake body 6 is an integral part of a brake device, not designated in any more detail, of the electrical machine 1. The rotor brake body 6 has essentially a rotationally symmetrical hollow-cylindrical shape. It may, for example, be shrunk onto the rotor shaft 4 or, as shown in the example of the following FIG. 2, be connected firmly to the rotor shaft 4 by means of radial fastening means. The rotor brake body 6 may be manufactured, for example, from steel or aluminum.

In the example of FIG. 1, the rotor brake body 6 is braked via its axial outside 9 facing away from the output side. To apply a brake force, a brake shoe 10 of a brake actuating device 11 lies opposite the axial outside 9 of the rotor brake body 6. The actuating device 11, in the example of FIG. 1, is a pneumatic lifting cylinder which, when acted upon with compressed air, actuates a brake tappet 12 in the direction of the axial outside 9 of the rotor brake body 6. The direction of actuation is indicated by an arrow. The actuating device 11 is preferably mounted on the machine housing 8 of the electrical machine 1.

To increase the brake torque transmission, the rotor brake body 6 has on its axial outside 9 a radial extension 13 which is at a greater radial distance from the rotor shaft 4 than the rest, shown, of the rotor brake body 6. The radial extension 13 forms, for example, a brake disk.

The rotor brake body 6 may also be braked via its radial outside 14. In this case, the radial outside 14 forms a brake hub.

A rotary encoder 15 for detecting a rotational movement of the rotor shaft 4 is illustrated in the right-hand part of FIG. 1. The rotary encoder 15 has a rotary encoder shaft 16, illustrated by dashes, which is connected fixedly in terms of rotation to an axial end 17 of the rotor shaft 4. Reference symbol 18 designates, for example, a cap for the mechanical protection of the rotary encoder 15.

FIG. 2 shows a longitudinal section through a rotor 3 according to the prior art. The rotor lamination bundle 5 is illustrated in the left-hand part of FIG. 2. The rotor brake body 6 is illustrated in the right-hand part of FIG. 2. The rotor brake body 6 is connected fixedly in terms of rotation to the rotor shaft 4 by radial fastening means 20. The mechanical connection shown is a positive and at the same time nonpositive connection.

The rotor brake body 6 may alternatively or additionally be shrunk onto the rotor shaft 4. A mechanical connection of this type is a purely nonpositive connection.

FIG. 3 shows a longitudinal section through a rotor 23 according to the invention. According to the invention, the rotor lamination bundle 5 and the rotor brake body 6 are directly connected fixedly in terms of rotation to one another.

In the example shown, the rotor brake body 6 bears against an axial end 17 of the nonoutput side of the rotor shaft 4, while the rotor lamination bundle 5 is arranged at an axial end of the output side of the rotor shaft 4.

Alternatively to this, the axial position of the rotor lamination bundle 5 and of the rotor brake body 6 may be interchanged.

In the example of FIG. 3, the rotor lamination bundle 5 and the rotor brake body 6 are connected to one another via their axial outsides 24, 25 which in each case face one another. Preferably, the two axial outsides 24, 25 are planar and, as shown in FIG. 3, are formed perpendicularly to the axis of rotation A of the rotor shaft 4. The two axial outsides 24, 25 may alternatively have any desired geometric surface shape, such as, for example, conical or crowned. It is essential that the two axial outsides 24, 25 are coordinated with one another in such a way that as large a common contact surface as possible is present for nonpositive torque transmission.

In the example of FIG. 3, a plurality of screws are present as fastening means 26. Preferably, the fastening means 26 are arranged, distributed regularly in the circumferential direction. The number of fastening means 26 may amount, for example, to 2, 3, 6, 8, etc. In the example of FIG. 3, the selected number is even, so that in each case two fastening means 26 lie exactly opposite one another in the sectional illustration shown. An example of a regular distribution is illustrated in FIG. 4.

Axially running clearances 27, 28, in which the fastening means 26 are arranged, are present in the rotor lamination bundle 5 and in the rotor brake body 6 for the purpose of receiving the fastening means 26.

The clearances located on the rotor lamination bundle side are designated by the reference symbol 27 and the clearances located on the rotor brake body side are designated by reference symbol 28. In the example of FIG. 3, the clearances 27 located on the rotor lamination bundle side each have an internal thread which is coordinated with an external thread of the screws 26 shown. The clearances 28 located on the rotor brake body side are bores, the diameter of which is slightly larger than the diameter of the internal thread of the clearances 27 located on the rotor lamination bundle side. For fastening, the respective screws 26 can be pushed through the bores 28 in the rotor brake body 6 and screwed into the clearances 27 in the rotor lamination bundle 5. The rotor lamination bundle 5 and the rotor brake body 6, by being screwed together, are firmly braced with one another. Bracing advantageously increases the torsional rigidity of the rotor 23 according to the invention.

Preferably, on the axial outside 9 of the rotor brake body 6, cylindrical depressions 29 are introduced, into which a respective screw head 30 of the screws 26 can be embedded when these are screwed in. The screw head 30 may, for example, be a hexagon socket screw head.

As a result, advantageously, a larger surface for braking the rotor 23 is available on the axial outside 9 of the rotor brake body 6.

The rotor lamination bundle 5 and the rotor brake body 6 have a radial extent which varies between a minimum value B and a maximum value C along the rotor shaft 4. Furthermore, the clearances 27, 28 in the rotor lamination bundle 5 and in the rotor brake body 6 are at a radial distance D from the rotor shaft 4 which is lower than the minimum value B. The radial distance D in this case relates to the maximum radial distance of the respective clearance 27, 28.

In the example of FIG. 3, the radial distance D has a value which is lower than the minimum value C. The clearances 27, 28 shown still run completely along the corresponding axially running intersection line in the rotor lamination bundle 5 and in the rotor brake body 6. With this proviso, the screws 26 are at as great a radial distance D as possible from the axis of rotation A. Moreover, the screws 28 are surrounded completely by the material of the rotor lamination bundle 5 or of the rotor brake body 6. Particularly high torque transmission between the two rotor bodies 5, 6 is thereby possible.

In the example of FIG. 3, both the rotor brake body 6 and the rotor lamination bundle 5 are shrunk onto the rotor shaft 4. In the cold state, the two rotor bodies 5, 6 have, for pushing onto the rotor shaft 4, an inside diameter which is slightly smaller than the outside diameter of the rotor shaft 4. As a result of the heating of the two rotor bodies 5, 6, the inside diameter widens slightly, so that it is possible to push them onto the rotor shaft 4. After cooling, a rotationally fixed nonpositive connection is established between the respective rotor body 5, 6 and the rotor shaft 4.

Alternatively to this, the rotor brake body 6 may be connected fixedly in terms of rotation to the rotor shaft 4 by means of additionally radially acting fastening elements, as shown in the embodiment of FIG. 2 according to the prior art. The fastening means used may be screws, bolts, pins, bosses or the like.

In the example of FIG. 3, the screws 26 correspond to an axially acting fastening device for connecting the rotor lamination bundle 5 to the rotor brake body 6.

Alternatively, a tensioning structure or a clamp may be used, which braces the two rotor bodies 5, 6 mechanically with one another. The tensioning structure may comprise, for example, a steel band or steel rope which is connected mechanically to those axial ends 31, 9 of the rotor bodies 5, 6 which do not face one another.

The rotor 23 according to the invention is an integral part of an electrical machine 1, such as, for example, an electric motor or generator. The electrical machine 1 may be a synchronous or asynchronous machine. An electrical machine of this type can advantageously be operated in a more highly dynamic manner.

In particular, as illustrated in FIG. 3, the electrical machine 1 is an electric motor with a brake device, not designated in any more detail, for braking and/or retaining the rotor 23. The rotor brake body 6 is in this case an integral part of the brake device.

According to the example shown in FIG. 3, the rotor brake body 5 may be braked or retained via the radial and/or axial outside 15, 9 of the rotor brake body 6 by means of a brake actuating device, not shown in any more detail. Actuation may take place, for example, electromechanically, pneumatically or hydraulically.

In the example of FIG. 4, the rotary encoder 15 of the electrical machine 1 is fastened to the axial end 17 of the rotor shaft 4. In the example of FIG. 4, the rotary encoder 15 is fastened to that axial end 17 of the rotor shaft 4 which is axially adjacent to the rotor brake body 6.

As a result, the axial distance between the rotor brake body 6 and rotary encoder 15 is so short that the torsional elasticity of the rotor 23 and, in particular, that of the rotor shaft 4 can be ignored for control purposes. The control or regulation of the electrical machine 1 can advantageously take place even more dynamically.

In particular, the electrical machine 1 according to the invention is a servomotor. Such servomotors may particularly advantageously be used in robotics and for the positioning of machine and plant components.

FIG. 4 shows a longitudinal section through the rotor 23 according to the invention along a sectional line IV-IV depicted in FIG. 3.

In the example of FIG. 4, for example, six screws 26 are arranged, distributed regularly in the circumferential direction of the rotor brake body 6, as fastening means. The screws 26 are arranged, offset at an identical angle W of 60° with respect to one another. The distribution of the fastening means 26 or screws may alternatively also take place within predefined regions.

1.-13. (canceled)

14. A rotor for an electrical machine, comprising:
a rotor shaft;
a rotor lamination bundle fastened on the rotor shaft; and
a rotor brake body fastened on the rotor shaft at an axial distance to the rotor lamination bundle,
wherein the rotor lamination bundle and the rotor brake body are connected to one another in direct fixed rotative engagement.

15. The rotor of claim 14, wherein the rotor lamination bundle and the rotor brake body are connected to one another via their confronting axial outsides.

16. The rotor of claim 14, further comprising an axially acting fastening device connecting the rotor lamination bundle and the rotor brake body to one another.

17. The rotor of claim 16, wherein the fastening device has a plurality of fasteners which are evenly spaced apart in a circumferential direction.

18. The rotor of claim 17, wherein the rotor lamination bundle and the rotor brake body have axial clearances for engagement of the fasteners.

19. The rotor of claim 18, wherein the rotor lamination bundle and the rotor brake body have a radial extent which varies between a minimum value and a maximum value along the rotor shaft, wherein the clearances are spaced at a radial distance from the rotor shaft which is smaller than the minimum value.

20. The rotor of claim 14, further comprising radially acting fastening elements for connecting the rotor brake body in fixed rotative engagement to the rotor shaft.

21. The rotor of claim 14, wherein the rotor brake body is shrunk onto the rotor shaft.

22. An electrical machine, comprising:
a stator; and
a rotor interacting with the stator and including a rotor shaft, a rotor lamination bundle fastened on the rotor shaft, and a rotor brake body fastened on the rotor shaft at an axial distance to the rotor lamination bundle, wherein the rotor lamination bundle and the rotor brake body are connected to one another in direct fixed rotative engagement.

23. The electrical machine of claim 22, constructed as an electric motor.

24. The electrical machine of claim 22, further comprising a brake device for braking and/or retaining the rotor, said rotor brake body being an integral part of the brake device.

25. The electrical machine of claim 22, further comprising a rotary encoder fastened to an axial end of the rotor shaft.

26. The electrical machine of claim 25, wherein the axial end of the rotor shaft is adjacent to the rotor brake body.

27. The electrical machine of claim 22, constructed as a servomotor.
